(19) United States
(12) Patent Application Publication
(10) Pub. No.: US 2007/0022465 A1
(43) Pub. Date: Jan. 25, 2007

(54) System and method for marking digital media content

(75) Inventor: Leigh M. Rothschild, Sunny Island, FL (US)

Correspondence Address: CASELLA & HESPOS, 274 MADISON AVENUE, NEW YORK, NY, 10016, US

(73) Assignee: Rothschild Trust Holdings, LLC, Sunny Isles Beach, FL (US)

(21) Appl. No.: 11/527,279

(22) Filed: Sep. 26, 2006

Related U.S. Application Data
(63) Continuation-in-part of application No. 10/034,832, filed on Dec. 28, 2001.
(63) Continuation-in-part of application No. 09/997,477, filed on Nov. 20, 2001.

(51) Int. Cl. H04N 7/16; G06F 15/00; G06F 17/00; H04N 7/173

(52) U.S. Cl. 725/136; 725/112; 725/113; 715/500.1; 715/501.1

(57) ABSTRACT

A system and method for marking digital content are provided. The system and method of the present disclosure enables a user to mark digital audio and/or video content with instructions so that the content can be controlled and/or hyperlinked to additional content including sites on the global computer network, e.g., the Internet, via a marking script. The system and method provide for navigating the digital content to at least one location; entering at least one instruction at the at least one location; determining a reference of the at least one location; and storing the at least one instruction with the determined reference in a script, wherein the script controls playback of the content. The reference of the location in the content may include but is not limited to a playing time of the content, a subtitle in the content or a frame of the content.

### CROSS REFERENCE TO RELATED APPLICATIONS

The present application is a continuation-in-part application of U.S. application Ser. No. 09/997,477, filed Nov. 20, 2001 entitled “INTERACTIVE, MULTI-USER MEDIA DELIVERY SYSTEM”, and a continuation-in-part application of U.S. application Ser. No. 10/034,832, filed Dec. 28, 2001 entitled “METHOD OF ENHANCING MEDIA CONTENT AND A MEDIA ENHANCEMENT SYSTEM”, the contents of both of which are hereby incorporated by reference.

### BACKGROUND

1. Field

The present disclosure relates generally to data processing and media playback systems, and more particularly, to a system and method for marking digital content for controlling playback of the digital content and for hyperlinking the digital content to additional content.

2. Description of the Related Art

There are presently a variety of different technologies available to deliver media selections, such as audio, video, audio/video, etc. to users in an effective and beneficial format. Moreover, there is a substantial volume of material available over computerized networks, such as the Internet which may or may not be related to specific media selections. Unfortunately, although a user may independently seek out additional materials and information associated with a specific media selection, presently no specific and effective facility exits for effectively enhancing a media selection with quantities of additional materials, without requiring separate independent machinery and separate and independent programming on the medium itself. Indeed, such is especially the case with regard to the large amounts of media already distributed and in use by the public.

Recent technological advances have made significant strides in what may be termed, enhanced DVDs or similarly enhanced media delivery products including CD-ROMs, hard drives, digital storage devices, and the like. These existing enhancements include the embedding and/or programming of additional content onto a specific media storage medium, such as the DVD, for effective communication to the user. As a result, merchants are able to sell these various media selections while promoting substantial enhancements, which can expand the marketability of a product which may or may not have already been viewed and/or heard by the consumer at a previous time. To this end, enhanced media players are also being developed continuously to take advantage of these enhanced media selections and avoid the need to use personal computers. Specifically, these media players may include Internet connectivity and/or a variety of other features that may previously have only been available on specific computer processors which also had media delivery capabilities. While such exiting technologies are effective and beneficial for the purposes of enhancing new releases and publications of various types of media selections as indicated, they are generally incapable of providing any enhancement capability whatsoever to already distributed media selections and/or live or remotely delivered media selections, such as through a cable or satellite system. Moreover, the enhancement provided with existing technology can become somewhat stagnant since the available additional materials and types of interaction or enhancements must be pre-programmed onto the storage medium, and thereby are permanently set. Also, typical enhancements available with present technologies are often provided in the form of add-ons which are available and accessible separate and apart from the delivery of the actual media selection itself such that there is no true, direct interactivity with the actual media selection being delivered, but rather later, separate opportunities for independent access and/or retrieval of additional materials are provided.

As such, it would be highly beneficial to provide a media enhancement system and method which is capable of direct, contemporaneous enhancement of a media selection being delivered so as to achieve true interactivity between a user and the media selection being delivered. Furthermore, such a system and method should be capable of continuous updating and/or modification by a controlling entity so as to continuously refresh and make attractive the delivery of a particular media selection, and/or tailor the type of enhancement to its audience. Moreover, such a system and method should be capable of being effectively utilized to its full capacity with any media selection, whether it is being delivered live, being delivered from a remote location, or being delivered via a local and/or removable storage medium that has been newly programmed or was pre-programmed and distributed before the availability of such technology. As a result, the enhancement capabilities would not be limited only to new releases of media selections.

### SUMMARY

A system and method for marking digital content are provided. The system and method of the present disclosure enables a user to mark digital audio and/or video content with instructions so that the content can be controlled and/or hyperlinked to additional content including sites on the global computer network, e.g., the Internet, via a marking script. The marking script will playback the content in a controlled manner, defined by a user, so as to provide new and/or additional content during playback. Since the script will be stored as a separate file from the content, the script may be continuously updated to provide new and/or fresh content regardless of when the original content was obtained or recorded.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of an exemplary system for marking digital content in accordance with an embodiment of the present disclosure;

FIG. 2 is a flow chart illustrating a method for marking digital content in accordance with an embodiment of the present disclosure;

FIG. 3 is a flow chart illustrating a method for marking digital content in accordance with another embodiment of the present disclosure; and

FIG. 4 is a flow chart illustrating a method for playing back digital content according to a script in accordance with an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for marking digital content, e.g., audio, video, etc., so the digital content can be controlled and hyperlinked to additional content via a marking script are provided. The system and method of the present disclosure enables a user to obtain and/or load digital content in a media player assembly, e.g., a computer, an enhanced DVD player, etc. The content could be audio and/or video content and can be transported into the media player assembly with any current or future digital storage medium including but not limited to optical media such as DVDs or CDs, removable hard disk storage medium, removable memory cards (CompactFlash, MMC, SD, Memory Stick, etc.). Alternatively, the user could use the global computer network or a local network to transport the content from a source to the media player assembly. Additionally, satellite, infrared, radio transmission of any type, or WiFi transmission can be utilized to transport the content into the media player assembly. The user will then use a user interface module (UIM) incorporating a digital playback decoding module (DPDM) to play the digital content. This playback module will allow the user to control the content including but not limited to Start, Stop, Pause, Go to, Zoom, Fast Forward, Reverse, etc. The user interface module (UIM) will be linked to a scripting module (SM) that will be stored in digital storage on the media player assembly (e.g. a hard drive, optical storage, etc), or stored digitally on a remote web site on the global computer network. The user will use the user interface (UIM) to instruct the scripting module (SM) how the user wishes the digital content to be played back in the future. The user will also use the user interface (UIM) to instruct a linking module (LM) as to what content located on the media player assembly, local network or global computer network, e.g., the Internet, to link to the digital content.

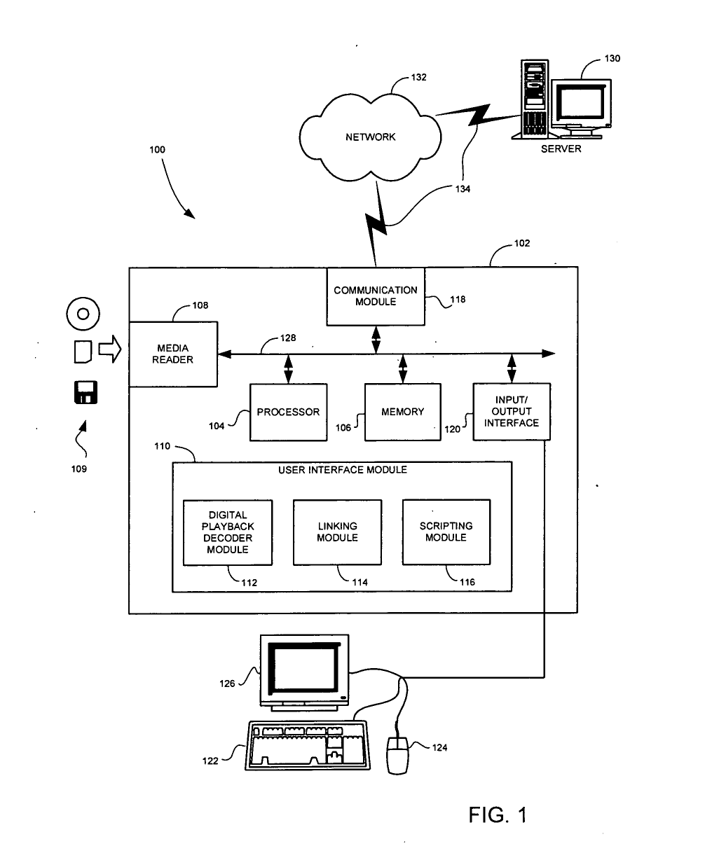

Referring to FIG. 1, a system 100 for marking digital content is illustrated. The system includes a media player assembly 102 for playing or delivering content to a user with a computer processor 104. The media player assembly 102 will also contain a digital memory storage device 106 that may be in the form of a removable or fixed hard disk device, or may be in the form of writeable memory, or may be in some other form hereto known or created in the future. The media player assembly 102 will also includes a media reader/writer 108 for reading from and writing to external storage media 109. In one embodiment of the present disclosure, the media reader 108 is a optical reader/writer (OR) that will read and process various optical media including but not limited to DVDs, CDs, CD-ROMs, and other types of optical media that may be currently available or available in the future. The optical reader/writer OR may also be able to write and store digital data. In another embodiment, the media reader 108 is a memory card reader/writer (MCR). The memory card reader (MCR) will read various removable memory including but not limited to CompactFlash, SD (Secure Digital) memory, MultiMediaCard (MMC), Memory Stick, SmartMedia and other memory currently existing or created in the future. The memory card reader (MCR) may also be able to write and store digital data.

The media player assembly 102 contains computer instructional code that is operated by the computer processor 104. This code functions to create a user interface module (UIM) 110 for navigating the digital content. The user interface module (UIM) also incorporates a digital playback decoder module (DPDM). The digital playback decoder module (DPDM) 112 is standard in the art and will playback any type of digital content currently existing including but not limited to DVR.MS files, AVI files, Mpeg (1, 2, 3, 4 5, etc) files, Tivo MPEG files, Replay files, VOB files, IFO files, AAC (audio) files, MP3 (audio) files, wmv (audio) files, Mpeg (audio) files and any digital media content file format currently existing or to be created in the future. The digital playback decoder module (DPDM) 112 allows the user to playback digital content and to selectively control the digital content. Different digital playback decoder module (DPDM) control units will have different functionality and this variance in functionality is not critical to the overall disclosure. Normal functionality will include but is not limited to instituting Play, Stop, Pause, Rewind, Fast Forward, Zoom of Video (either in a still mode or in a moving mode), freeze frame, Sound Volume up, Sound Volume Down, Sound Muted, Go to a certain time, Go to Certain Chapter, Go to end, Go to beginning, and overlay text onto the screen or playback engine.

The user interface module (UIM) 110 will also include a linking module (LM) 114, that will allow the user to navigate to a particular part of the digital content using the digital playback decoder module (DPDM) 112 and, then when at the spot in the desired content, to have the user use the linking module (LM) 114 to access the global computer network, e.g., the Internet, and identify a web page or pages on the global computer network (e.g., a web site) that the user wants to link the digital content to. In another embodiment of the present disclosure, the user could direct the linking module (LM) 114 to link the content to either local content stored in the memory 106 or stored on external media disposed in the media reader 108, e.g., an OCR or MCR. Still another embodiment would allow the user to use the linking module (LM) 114 to link to content stored on a local computer network coupled to the to the media player assembly 102 via communication module 118. It is to be appreciated that the linked content may be any currently available content including but not limited to an audio file, video file, multimedia file, application file, web site or web page or any content to be developed in the future.

The user interface module (UIM) 110 will communicate with a scripting module (SM) 116. The scripting module (SM) 116 will receive the user's instructions from the user interface module (UIM) 110, record these instructions, and store the instructions as a script either in writeable memory, removable or fixed memory (e.g., memory 106) or alternatively store the instructions on external media 109 disposed in media reader 108. Alternatively, the script may be stored at a remote location either through a computer network or the global computer network, e.g., the Internet.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by a machine, e.g., media player assembly 102, comprising any suitable architecture such as a personal computer, a workstation or server. Preferably, the media player assembly 102 is implemented on a computer platform having hardware such as one or more central processing units (CPU), a random access memory (RAM), a read only memory (ROM) and input/output (I/O) interface(s) 120 such as a keyboard 122, cursor control device 124 (e.g., a mouse or joystick) and display device 126, e.g., a monitor. A system bus 128 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform of the machine by various interfaces and bus structures, such a parallel port, serial port or universal serial bus (USB). One such peripheral device may include a communication module 118, e.g., a modem, satellite relay, wireless connection, etc., for enabling communications from the media player assembly 102 to various servers. Other peripheral devices may include additional storage devices, a printer and a scanner.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The media player assembly 102 may operate in a networked environment using logical connections to one or more remote computers, e.g., server 130. The remote computer may be a personal computer, a server, a router, a network PC, a peer device or other common network node, and typically includes many or all of the elements described above relative to the machine. It is to be appreciated that the network 132 may be a local area network (LAN), wide area network (WAN), the Internet or any known network that couples a plurality of computers to enable various modes of communication via network messages. The media player assembly 102 may communicate to the server 130 and network 132 via any known communication link 134, for example, dial-up, hardwired, cable, DSL, satellite, cellular, PCS, wireless transmission (e.g., 802.11a/b/g, etc.), etc. Furthermore, the devices will communicate using the various known protocols such as Transmission Control Protocol/Internet Protocol (TCP/IP), File Transfer Protocol (FTP), Hypertext Transfer Protocol (HTTP), etc. During a purchasing transaction, the computing devices may employ Hypertext Transfer Protocol Secure (HTTPs), Secure Sockets Layer (SSL) Protocol, Secure Electronic Transaction (SEC) Protocol, etc.

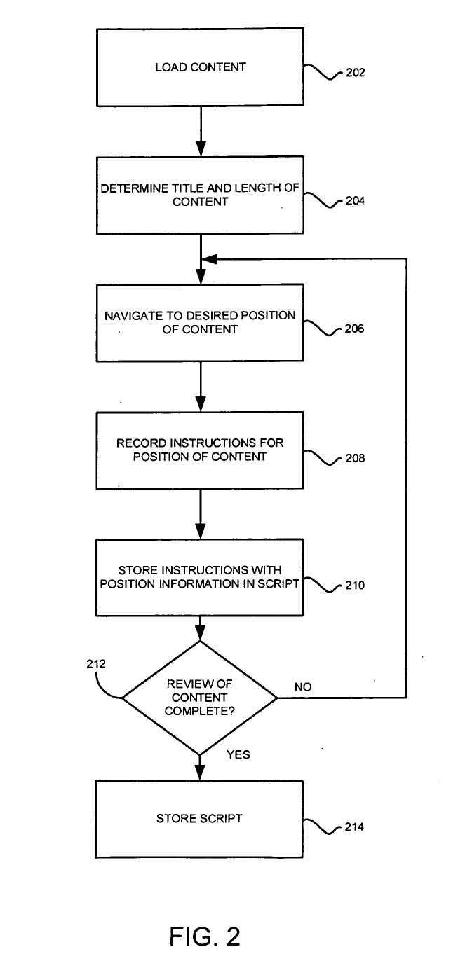

With reference to FIGS. 1 and 2, a system and method of the present disclosure will now be described, where FIG. 2 is a flow chart illustrating a method for marking digital content with instructions for controlling playback of the digital content.

Initially, in step 202, digital content is loaded in the media player assembly 102. In one embodiment of the disclosure, a user will insert digital content into the media reader 108. The user will then call up the user interface module (UIM) 110 which is powered by the processor 104 contained within the media player assembly 102. The user interface module (UIM) 110 will generate a user interface to control the decoder module (DPDM) 112. The user interface module (UIM) 110 will then receive information from the digital content as to the overall length of the content and the title of the content (step 204). This information is routinely recorded within the digital content and may include overall playing time of the content, frame sequence numbers of video content, chapters of video content, numbered tracks of audio content, etc. The user interface module (UIM) 110 will provide this information to the scripting module (SM) 116 and the content length and title will also be recorded by the scripting module (SM) 116.

In step 206, the user may now use the user interface module (UIM) 110 to navigate to any position or location within the digital content. When the user reaches the location within the content that he wishes to mark, the user will then instruct scripting module (SM) 116 what he wants to do in that location via the user interface module (UIM) 110. Possibilities of instructions input by the user include freeze a certain frame of the content, raise or lower the volume for a section of the content, playback a certain section of the content, post a note at a certain section of the content, or zoom a certain section of the content. Any instructions that the user provides the user interface module (UIM) 110 will be recorded (step 206) and stored by the scripting module (SM) 116 in script along with a reference of the marked position of the content (step 210). For instance, if the user wants to play a certain section of the content, he would go to the first location of the content and tell the scripting module (SM) 116 to mark that section as the start point. The scripting module (SM) 116 would then note the exact time code, or other position reference, of the section that the user has indicated. The user would then use the user interface module (UIM) 110 to advance to the desired end location of the content. Again, the user would tell the scripting module (SM) 116 to record the time location of the end point.

The user would continue to go thorough the entire digital content with the user interface module (UIM) 110 and would continue to instruct the scripting module (SM) 116 of any time point or reference in the content that the user wishes to institute certain actions mentioned above. Similarly, at any time point within the content, the user can input via the user interface module (UIM) 110 that at that certain time point the user wants to have the digital playback of the content halted and the content to be replaced with a particular page or pages on the global computer network, e.g., the Internet. These page indications will be specified by the user and recorded and later stored as standard URL web site page addresses, by the scripting module (SM) 116.

In another embodiment, the user may post a note or notes during playback of the content, so that another user viewing the playback is presented with various options including the option to stop the playback and go to any link on the global computer network or local network that the first user has provided. In this embodiment, the user will use the user interface module (UIM) 110 to locate the exact time spot within the content that he wishes to post the note. The scripting module (SM) 116 will record this time location, and additionally record the note that the user wants to post at that time location. In a further embodiment, the note inserted by the user may include a hyperlink to an Internet/network location. The scripting module (SM) 116 will also record the address (URL) location of the desired hyperlink.

The user may mark a plurality of locations throughout the content. After a review of the content is complete (step 212), the user will instruct the user interface module (UIM) 110 that marking of the content is complete. The user interface module (UIM) 110 will instruct the scripting module (SM) 116 that the review of the content is complete and the scripting module (SM) 116 will store the script (step 214). It is to be appreciated that the script will be associated with the digital content to be identified for later retrieval via an identifier, e.g., the title of the content. The script may be stored in the fixed memory 106 of the media player assembly 102 or on any external storage medium 109 disposed in the media reader. In one embodiment, the script will be stored on the same medium that contains the digital content via the media reader/writer 108. In another embodiment, the script will be stored on remote server 130 and will be available for access by other users. By storing the script on a remote server 130 coupled to the Internet, several network users may simultaneously view the controlled playback. A method and system for providing simultaneous viewing of content to a plurality of users over a network is described in commonly owned U.S. application Ser. No. 09/997,447, the contents of which are hereby incorporated by reference.

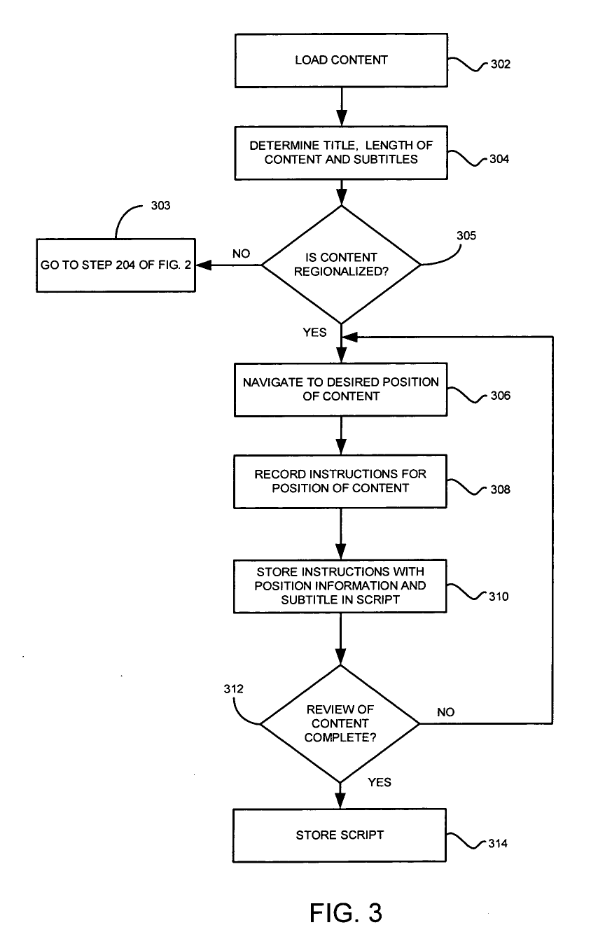

Referring to FIG. 3, a method for marking digital content according to another embodiment of the present disclosure is illustrated. In step 302, the user will locate digital content that has been stored in memory 106 and load the content on the media player assembly 102. This content may be a digital file for a television recording such as a Tivo™ file or a Microsoft™ DVR.ms file. The user will then call up the user interface module (UIM) 110 which is powered by the processor 104 contained within the media player assembly 102. The user interface module (UIM) 110 will generate a user interface to control the decoder module (DPDM) 112. The user interface module (UIM) 110 will then receive information from the digital content such as the overall length of the content, the title of the content and/or subtitles associated with the content (step 304). Here, the user can also decide whether the content file that they are accessing is content that is the same for anyone that has recorded it nationally, or whether the content is regionalized, meaning the core content may be the same, but the time coding of where the content occurs in the file would vary from region to region. In a preferred embodiment of the present disclosure, processor 104 would analyze the content using a preprogrammed instructional codeset and would determine for the user whether the content is national or regional. Alternatively, the media player assembly 102 may seek to determine the nature of the content by having the user interface module (UIM) 110 contact a remote server site through the Internet where information on the digital file (e.g., whether the content is national or local) would be then sent back to the user interface module (UIM) 110. If it is determined that the subject digital content file is regional at step 305, then the user or the processor 104 will activate the user interface module (UIM) 110 so that the user interface module (UIM) 110 will receive and process the digital subtitles that are present as part of the digital content and appear within a substantial amount of recorded digital content. Otherwise, if it is determined that the subject content is not regionalized, the method for marking the content will proceed to step 204 of FIG. 2 and proceed as described above (step 303).

In the instance where the processor 104 or user determines that the content is regionalized, then the user interface module (UIM) 110 will provide this information to the scripting module (SM) 116 and the content length and title will also be recorded by the scripting module (SM) 116. The user may now use the user interface module (UIM) 110 to navigate to any position within the digital content (step 306). When the user reaches the location within the content that he wishes to mark, the user will then instruct the user interface module (UIM) 110 on what he wants to do in that location. Actions to be performed at marked locations include freeze a certain frame of the content, raise or lower the volume for a section of the content, playback a certain section of the content, post a note at a certain section of the content, or zoom a certain section of the content. Any instructions that the user provides the user interface module (UIM) 110 will be recorded and later stored by the scripting module (SM) 116 (step 308). For instance, if the user wants to play a certain section of the content, the user would go to the first location of the content and tell the user interface module (UIM) 110 to mark that section as the start point. The scripting module (SM) 116 would then note the exact string of subtitles and an estimated location of the subtitles for the section that the user has indicated. In this embodiment, the subtitles are to be employed as the reference for the position in the content. The user will then use the user interface module (UIM) 110 to advance to the desired end location of the content. The scripting module (SM) 116 will record the exact string of subtitles and an estimated location of the subtitles of the section that the user has indicated along with any instructions the user has provided (step 310). The user could continue to go through the entire digital content with the user interface module (UIM) 110 which in turn would continue to instruct the scripting module (SM) 116 of any string of subtitles and the estimated location of those subtitles in the content that the user wishes to institute certain actions as indicated above (step 312). At any location within the content, the user can instruct the user interface module (UIM) 110 to note the string of subtitles that are occurring at that location and then the user can instruct the user interface module (UIM) 110 that at that certain subtitle string the user wants to have the digital playback halted and the content to be replaced with a particular page or pages (web pages) on the Internet. These page indications will be specified by the user and recorded and later stored as standard URL web site page addresses, by the scripting module (SM) 116. In another embodiment, the user may post a note or notes during playback of the content, so that the person viewing the playback is presented with various options including the option to stop the playback and go to any link on the global computer network or local network that the user has provided. In this case, the user will use the user interface module (UIM) 110 to locate the subtitle string and approximate location within the content that he wishes to post the note. The scripting module (SM) 116 will record this string, and additionally record the note that the user wants to post at that string. Further, if the note is a hyperlink to a Internet/network location, the scripting module (SM) 116 will also record the address (URL) location on the network or global computer network of the desired hyperlink.

After a review of the content is complete (step 312), the user will instruct the user interface module (UIM) 110 that marking of the content is complete. The user interface module (UIM) 110 will instruct the scripting module (SM) 116 that the review of the content is complete and the scripting module (SM) 116 will store the script (step 314). It is to be appreciated that the script will be associated with the digital content to be identified for later retrieval via an identifier, e.g., the title of the content.

Although the above embodiments were described in relation to video digital content such as motion pictures, televisions programs, etc., the principles of the present disclosure may be applied to other various types of known content. For example, in the case where the digital content is recorded and stored music in digital optical form (such as in audio DVDs and music cds) or digital file formats (such as in mp3, aac, wmv files, etc.), the user will locate the file within the memory 106 or place a medium including file into the media reader 108. The user will then call up the user interface module (UIM) 110 which is powered by the processor 104 contained within the media player assembly 102. The user interface module (UIM) 110 will generate a user interface to control the decoder module (DPDM) 112. The user interface module (UIM) 110 will then receive information from the digital content such as the overall length of the content and the title of the content. The user may now use the user interface module (UIM) 110 to navigate to any position within the digital content, e.g., a particular numbered track. When the user reaches the location within the content that he wishes to mark, the user will then instruct the user interface module (UIM) 110 what he wants to do in that location. Possible actions include but are not limited to pausing the music content at that point, increasing the volume of the content for a certain segment of playback, lowering the volume of the content for a certain segment of the playback, playing back the content in a certain order, repeating certain sections of the content, or posting a note at a certain section of the content. Any instructions that the user provides the user interface module (UIM) 110 will be recorded and later stored by the scripting module (SM) 116 as described above.

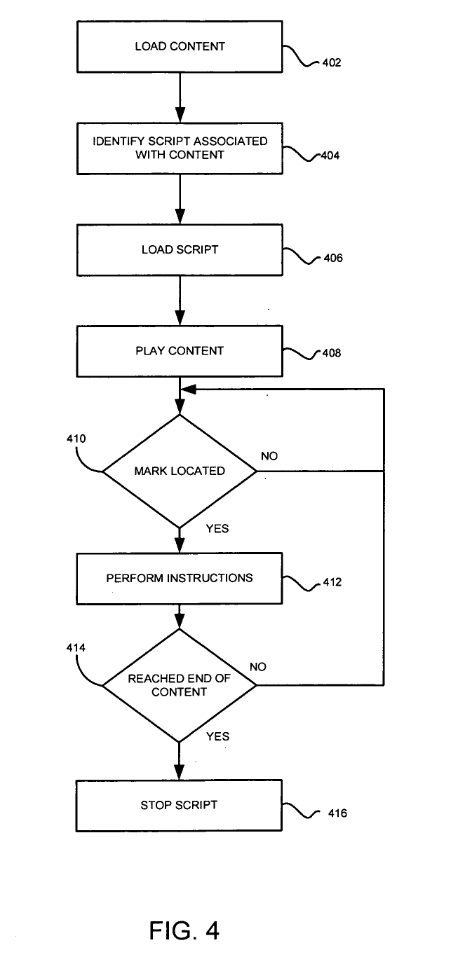

Once the scripts are stored, the scripts may by accessed by anyone that would be given access to the scripts. If the user that accesses the scripts has the same digital content that the script references, the user will be able to play back the digital content according to the script. Referring to FIG. 4, a method for playing back digital content according to a script in accordance with an embodiment of the present disclosure is illustrated.

In step 402, a user will load the desired content. As described above, the content may be loaded by placing an external medium into media reader 108, locating the content file stored in memory 106, accessing the content over a network by the communication module 118, etc. Once the content is loaded, the media player assembly 102 will determine an identifier of the associated script, e.g., the title of the content, (step 404) and locate and load the script (step 408). Alternatively, the user may locate the script by navigating through memory with the cursor control device 124. The user will now play the content via the user interface module (UIM) 110 (step 408). The script will execute and run concurrently with the content. When a mark is located by the script (step 410), e.g., a time from the start of the content, the scripting module (SM) 116 will send the instructions to the decoder module 112 and/or the linking module (LM) 114 to perform the instructions for that mark (step 412). After the instructions for the particular mark are performed, the media player assembly 102 will determine if the end of the content is reached (step 414). If the end of the content was not reached, the scripting module (SM) 116 will loop back to step 410 and continue to search for marks. Otherwise, if the end of the content is reached, the content will stop playing and the script will stop (step 416).

Various applications of the disclosure are described below:

A user places the movie DVD Harry Potter™ in the media reader 108 of the media player assembly 102. The user then calls up the user interface module (UIM) 110 and uses the decoder module (DPDM) 112 to playback the movie. The user decides that he wishes the movie to playback starting with the third chapter of the movie so he uses the user interface module (UIM) 110 to navigate to this third chapter. The user then uses the user interface module (UIM) 110 to mark this as the starting point of the movie, and to play this third chapter of Harry Potter until the fourth chapter. He then navigates to the fourth chapter and tells the user interface module (UIM) 110 that as the movie starts the fourth chapter it should go to the beginning opening credits of the movie. Further, the user may now navigate via the user interface module (UIM) 110 to a scene in the movie where Harry Potter is present full screen. The user may now input to the user interface module (UIM) 110 that when this image is on the screen to freeze the screen image and to put an overlay on the screen that will allow the user to go to the network/Internet and link to the Internet Movie Data Base site (http://www.imdb.com/name/nm0705356/) that contains information on the actor who plays Harry Potter, Daniel Radcliffe. The user also instructs the user interface module (UIM) 110 that after the Internet site is viewed and the user clicks playback, at what point new point the movie will now commence. All the above instructions input by the user will be recorded in a script by the scripting module 116 and associated with an identifier, e.g., the movie title, of the content for later retrieval.

In another example, a user places the optical DVD content for the movie Return to Titanic in the media reader 108 of the media player assembly 102. The user then uses the user interface module (UIM) 110 to navigate to exactly 12 minutes into the movie. The user then instructs the user interface module (UIM) 110 that at this point he wishes the movie to pause and the user to be taken to a site on the global computer network (the site location is specified by the user via the linking module 114) where the user will have additional information on the content presented in an interactive format. This format could include questions relating to the digital content that was viewed and these questions could be then scored by the remote server computer 130 to gauge the user's comprehension of the content. The user will indicate to the user interface module (UIM) 110 that depending on the score how to modify the script, i.e., where to tell the user interface module (UIM) 110 to next playback the movie. For example, in the case of a low score, the scripting module (SM) 116 will repeat the previously played content; otherwise, the scripting module (SM) 116 will resume forward in the content.

In still another example, a user locates digital content that has been recorded and stored in the media player assembly 102, e.g., in memory 106. In this example, the content is a Microsoft Media Center file (e.g., DVR.ms file). The file contains the recording of the television show West Wing™. The user utilizes the user interface module (UIM) 110 to navigate through the recorded content. At a certain point, the users instructs the user interface module (UIM) 110 that he wishes to pause the playback and to link the user to the White House web site (www.whitehouse.gov) via the linking module (LM) 114. The user now instructs the user interface module (UIM) 110 to continue playback and the user instructs the user interface module (UIM) 110 to pause the playback at the end of the first 15 minutes and to post a note that the user wants posted on this section of the content.

In a further example, a user wants to playback a movie DVD but wishes to censor the content (perhaps for the user's children). The user places the DVD in the media reader 108 of the media player assembly 102. The user will use the user interface module (UIM) 110 to navigate to an offensive scene of the movie. At the offensive scene, the user will instruct the user interface module (UIM) 110 to either mute the audio for offensive language, skipped over the scene containing the offensive material, replace the offensive scene with an alternate scene, etc. All of the instructions inputted by the user will be stored in a script by the scripting module (SM) 116. Here, the script will allow playback of the material but will play it back in a fashion that will censor the content. In this fashion, the user will experience the DVD or movie content at a ratings level appropriate to their tastes and/or age.

At the end of all of these examples, the user will save the script created by the user interface module (UIM) 110 and the scripting module (SM) 116 will store the script on the media player assembly (either on removable or fixed memory). Alternatively, the script can be sent via the network/Internet to a web site for storage and later retrieval. Once the script is stored (remotely or locally), the script can be retrieved and played by the system and method that is described in co-pending U.S. application Ser. No. 10/034,832, the contents of which are hereby incorporated by reference in their entirety.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A system for marking digital content, the system comprising:
a media player assembly comprising:
a playback decoder module configured for playing and selectively controlling the digital content;
a user interface module configured to navigate the digital content to at least one location and to enter at least one instruction to be performed at the at least one location; and
a scripting module configured to determine a reference of the least one location of the digital content, associate the at least one instruction with the reference and store the reference and the associated at least one instruction in a script.

2. The system as in claim 1, wherein the media player assembly further comprises a linking module configured to link at least one second content to the at least one location of the digital content.

3. The system as in claim 2, wherein the at least one second content is an audio file, video file, multimedia file, application file, web site or web page.

4. The system as in claim 2, wherein the at least one second content is located remotely from the system.

5. The system as in claim 1, wherein the script is stored in a fixed memory, removable memory or a remote location.

6. The system as in claim 1, wherein the script is stored on a remote server.

7. The system as in claim 6, further comprising at least one second media player assembly, wherein the remote sever is configured to simultaneously control the content being played at the first media player assembly and the at least second media player assembly via the script.

8. The system as in claim 1, wherein the media player assembly further comprises a media reader/writer configured to read the digital content from a medium and to write the script on the medium with the digital content.

9. The system as in claim 8, wherein the medium is removable media.

10. The system as in claim 1, wherein the at least one instruction is playback the content, pause the content, digitally zoom the content, fast forward the content, rewind the content, play certain selections of the content, raise the volume of content, lower the volume of content, mute the volume of content or link the content.

11. The system as in claim 1, wherein the at least one instruction is a text note to be displayed when playing the content.

12. The system as in claim 11, wherein the text note includes a hyperlink to at least one remote web site.

13. The system as in claim 1, wherein the reference of the at least one location is a playing time of the digital content.

14. The system as in claim 1, wherein the reference of the at least one location is a subtitle occurring in the digital content.

15. The system as in claim 1, wherein the reference of the at least one location is a frame of video content, a chapter of video content or a scene of video content.

16. The system as in claim 1, wherein the at least one instruction hyperlinks a user to a web page of a remote server, the remote server configured to prompt the user with interaction regarding the content and based on a result of the interaction modify the script for playback to the user.

17. A method for delivering digital content comprising:
navigating the digital content to at least one location;
entering at least one instruction at the at least one location;
determining a reference of the at least one location; and
storing the at least one instruction with the determined reference in a script, wherein the script controls playback of the content.

18. The method as in claim 17, further comprising associating the script with at least one identifier of the content.

19. The method as in claim 17, further comprising:
playing the content until the reference is located; and
performing the at least one instruction associated with the reference via the script.

20. The method as in claim 19, wherein the at least one instruction links at least one second content to the at least one location of the digital content.

21. The method as in claim 20, wherein the at least one second content is an audio file, video file, multimedia file, application file, web site or web page.

22. The method as in claim 20, wherein the at least one second content is located remotely from the system.

23. The method as in claim 18, wherein the script is stored on a remote server.

24. The method as in claim 18, further comprising simultaneously controlling the content being played to at least two users via the script.

25. The method as in claim 17, wherein the digital content is disposed on removable media, further comprising writing the script on the media with the digital content.

26. The method as in claim 19, wherein the at least one instruction is playback the content, pause the content, digitally zoom the content, fast forward the content, rewind the content, play certain selections of the content, raise the volume of content, lower the volume of content, mute the volume of content or link the content.

27. The method as in claim 19, wherein the at least one instruction is a text note to be displayed when playing the content.

28. The method as in claim 19, wherein the text note includes a hyperlink to at least one remote web site.

29. The method as in claim 19, wherein the reference of the at least one location is a playing time of the digital content.

30. The method as in claim 19, wherein the reference of the at least one location is a subtitle occurring in the digital content.

31. The method as in claim 19, wherein the reference of the at least one location is a frame of video content, a chapter of video content or a scene of video content.

32. The method as in claim 19, wherein the at least one instruction hyperlinks a user to a web page of a remote server, further comprising
prompting the user with interaction regarding the content; and
based on a result of the interaction, modifying the script for playback to the user.

33. The method as in claim 32, wherein the modifying the script includes replaying previously played portions of the content.

34. A program storage device readable by a machine, tangibly embodying a program of instructions executable by the machine to perform method steps for delivering digital content, the method steps comprising:
navigating the digital content to at least one location;
entering at least one instruction at the at least one location;
determining a reference of the at least one location; and
storing the at least one instruction with the determined reference in a script, wherein the script controls playback of the content.
